(19) United States
(12) Patent Application Publication
(10) Pub. No.: US 2010/0012267 A1
(43) Pub. Date: Jan. 21, 2010

(54) ROBUST ELECTRODES FOR SHAPE MEMORY FILMS

(76) Inventors: Jennifer Hoyt Lalli, Blacksburg, VA (US); Richard Otto Claus, Eggelston, VA (US); William Lamont Harrison, Riner, VA (US); Victor Vincent Baranauskas, III, Christiansburg, VA (US); Lacy Maxwell Bush, Christiansburg, VA (US); Michael Jeremiah Bortner, Blacksburg, VA (US)

Correspondence Address: SHERR & VAUGHN, PLLC, 620 HERNDON PARKWAY, SUITE 320, HERNDON, VA, 20170, US

(21) Appl. No.: 12/500,280

(22) Filed: Jul. 9, 2009

Related U.S. Application Data
(63) Continuation of application No. 11/941,938, filed on Nov. 17, 2007.
(60) Provisional application No. 60/866,375, filed on Nov. 17, 2006.
(60) Provisional application No. 60/866,359, filed on Nov. 17, 2006.
(60) Provisional application No. 60/884,529, filed on Jan. 11, 2007.
(60) Provisional application No. 61/079,807, filed on Jul. 10, 2008.

(51) Int. Cl. B32B 37/00

(52) U.S. Cl. 156/273.1; 156/60; 977/773

(57) ABSTRACT

An apparatus (e.g. a shape memory device) that includes a nano-particle layer, a linking agent layer, and a shape memory layer. An electrode for heating shape memory material during shape transitions of the shape memory layer may include the nano-particle layer and the linking agent layer. The nano-particle layer may include conductive nano-size particles (e.g. gold clusters having a diameter less than 100 nanometers or less than 50 nanometers). The electrode may be substantially resilient to deformation of the shape memory material due to individual bonding of individual particles of the nano-particle layer to the shape memory layer and/or the linking agent layer.

The present application is a continuation of pending U.S. patent application Ser. No. 11/941,938 (filed Nov. 17, 2007), which claims priority to U.S. Provisional Patent Application No. 60/866,375 (filed Nov. 17, 2006), U.S. Provisional Patent Application No. 60/866,359 (filed Nov. 17, 2006), and U.S. Provisional Patent Application No. 60/884,529 (filed Jan. 11, 2007), which are all hereby incorporated by reference in their entireties. The present application claims priority to U.S. Provisional Patent Application No. 61/079,807 (filed Jul. 10, 2008), which is hereby incorporated by reference in its entirety.

### BACKGROUND

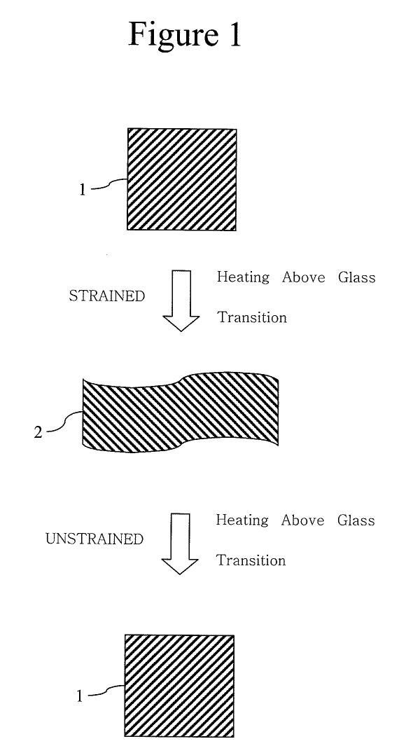

Shape memory is the ability of a material to remember its original shape after mechanical deformation. As illustrated in example FIG. 1, shape memory material 1 may have an initial shape. Shape memory material 1 may be heated above its glass transition temperature and strained (i.e. deformed) into shape memory material 2. Shape memory material 2 may maintain its deformed shape if it is cooled below its glass transition temperature while still under the mechanical strain that caused the deformation. If shape memory material 2 is then again heated above its glass transition temperature while being unstrained, it will transform back to shape memory material 1, thus resuming its original shape.

These properties of shape memory materials have applications in aerospace technologies, automotive technologies, electronics, entertainment, and any other applications where repeatable shape changing is a desired feature. For example, in satellites, shape memory materials may be used to inflate a relatively large antenna in space that is stored in a relatively small protected compartment in the satellite during launch and orbiting of the satellite, with repeatable and dependable deployment.

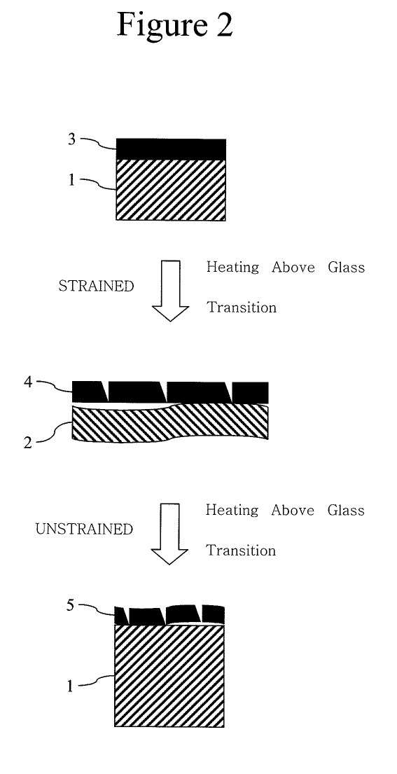

In shape memory applications, shape memory material should be heated in an effective and efficient manner. As illustrated in example FIG. 2, electrode 3 may be formed on shape memory material 1 to produce heat. For example, a voltage and/or current may be applied to electrode 3 to generate heat through shape memory material 1 through the inherent electrical resistance of shape memory material 1. The heat generated by electrode 3 may be larger than the glass transition temperature of shape memory material 1. In some applications, electrode 3 may be a conductive thin film (e.g. a sputter coated thin gold film). When shape memory material 1 is heated through electrode 3, it may be strained to shape memory material 2. When shape memory material 1 is strained to shape memory material 2, electrode 3 is also strained into electrode 4. Since electrode 3 is a conductive thin film, when it is strained to electrode 4, it may crack and/or become delaminated from shape memory material 2 or otherwise structurally deteriorate. When shape memory material 2 is transformed back to shape memory material 1 (through heating using electrode 4), electrode 3 may be permanently damaged, resulting in damaged electrode 5 (e.g. cracked and/or delaminated).

Accordingly, damaged electrodes 4 and 5 illustrated in example FIG. 2 may cause complications. Damaged electrodes 4 and 5 may be so structurally deteriorated that they can not enable the necessary production of heat in shape memory material 1 and/or shape memory material 2 to cause shape transitions. Damaged electrodes 4 and 5 may compromise the repeatability, efficiency, effectiveness, and/or dependability of shape memory materials in many applications. For example, a shape memory material may be itself undamaged, but rendered unusable due to damaged electrodes.

### SUMMARY

Embodiments relate to an apparatus (e.g. a shape memory device) that includes a nano-particle layer, a linking agent layer, and a shape memory layer. An electrode for heating shape memory material during shape transitions of the shape memory layer may include the nano-particle layer and the linking agent layer. The nano-particle layer may include conductive nano-size particles (e.g. gold clusters having a diameter less than 1000 nanometers or less than 50 nanometers). The electrode may be substantially resilient to deformation of the shape memory material due to individual bonding of individual particles of the nano-particle layer to the shape memory layer and/or the linking agent layer.

In embodiments, since the conductive material of an electrode is nano-size conductive particles (e.g. nano-size gold clusters) that are independently bonded to the deformable shape memory layer (and/or linking agent layer), the electrode will not substantially deteriorate due to strain of the shape memory layer. In other words, the conductive particles (e.g. nano-size gold clusters) of the nano-particle layer may strain with the shape memory layer. In embodiments, although the conductive nano-particles may be electrically coupled to each other (i.e. electrical current can flow between the conductive particles), they are not structurally bonded to each, but rather the conductive nano-particles are bonded to the shape memory layer (and/or linking agent layer). Since the conductive nano-particles are not bonding to each other, when the nano-particle layer is strained with the shape memory layer, the conductive nano-particles remain structurally stable, thus substantially avoiding crack or delamination or other structural deterioration.

In many applications (e.g. satellite technologies), embodiments will result in dependable shape memory materials. For example, in satellites, shape memory materials may be used to inflate a relatively large antenna in space that is stored in a relatively small protected compartment in the satellite during launch and orbiting of the satellite, with repeatable and dependable deployment that are not compromised by deteriorating electrodes.

### DRAWINGS

Example FIG. 1 illustrates a shape memory material transforming between two different shapes.

Example FIG. 2 illustrates structural deterioration of a thin film sputter coated electrode due to deformation of a shape memory material.

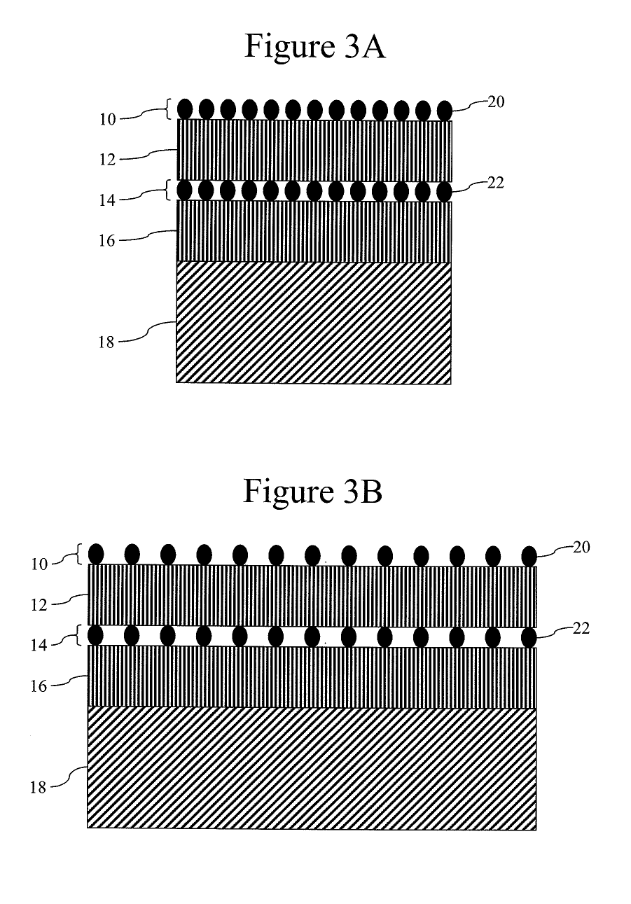

Example FIGS. 3A and 3B illustrates shape memory material with an electrode having nano-size conductive particles that does not substantially deteriorate due to strain of the shape memory material, in accordance with embodiments.

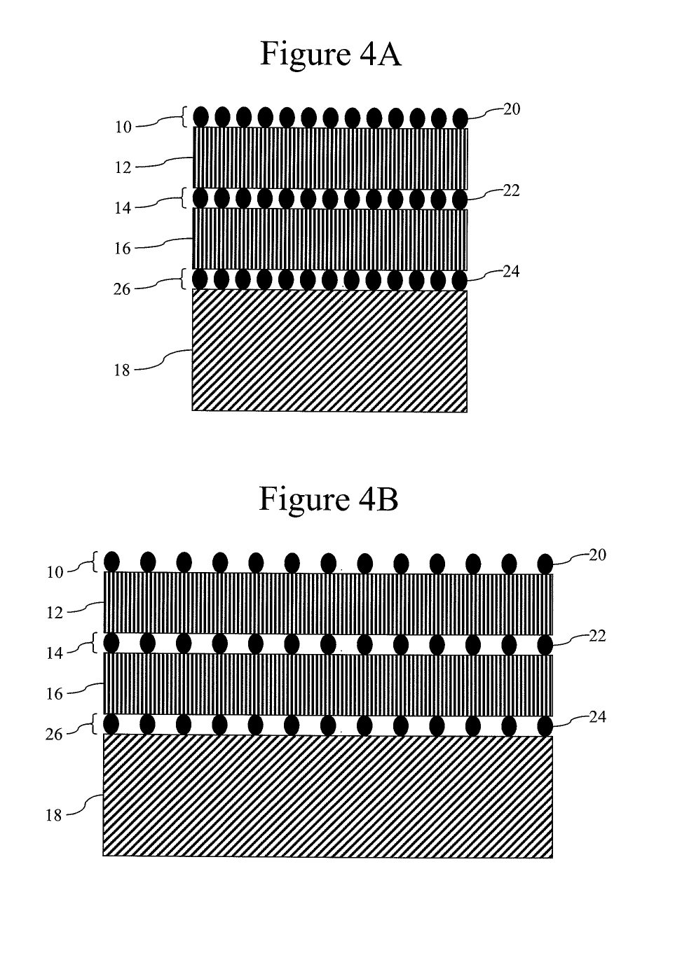

Example FIGS. 4A and 4B illustrates shape memory material with an electrode having nano-size conductive particles that does not substantially deteriorate due to strain of the shape memory material, in accordance with embodiments.

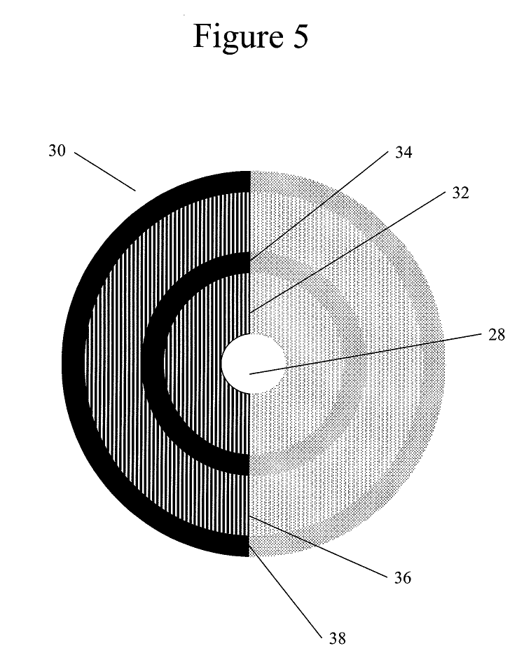

Example FIG. 5 illustrates a conductive nano-particle layer and a linking agent layer formed over a fiber, in accordance with embodiments.

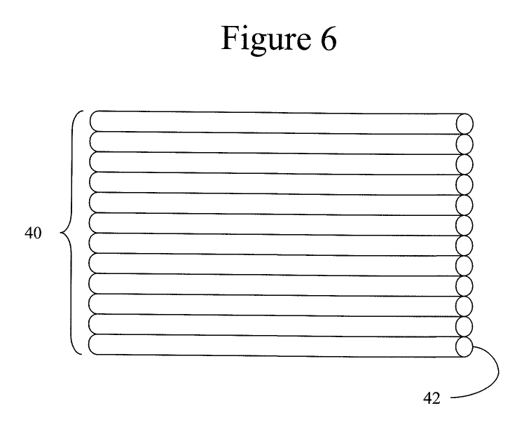

Example FIG. 6 illustrates a deregistered fiber array (including conductive nano-particle layers), in accordance with embodiments.

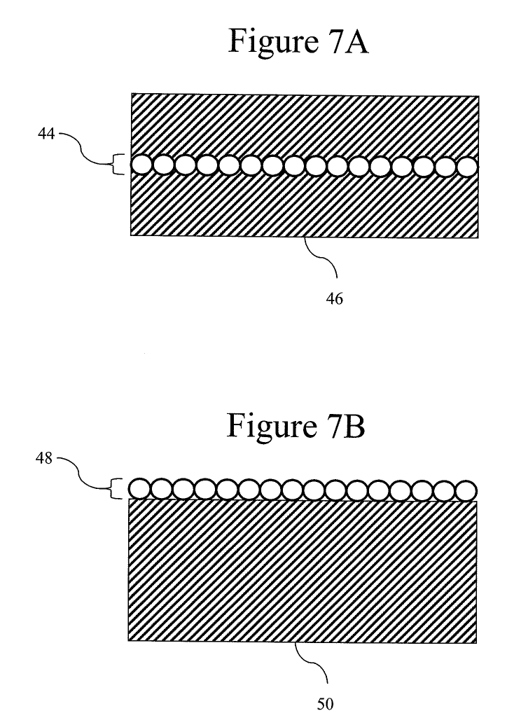

Example FIG. 7A illustrates a deregistered fiber array (including conductive nano-particle layers) that is integrated into shape memory material, in accordance with embodiments.

Example FIG. 7B illustrates a deregistered fiber array (including conductive nano-particle layers) that is formed over shape memory material, in accordance with embodiments.

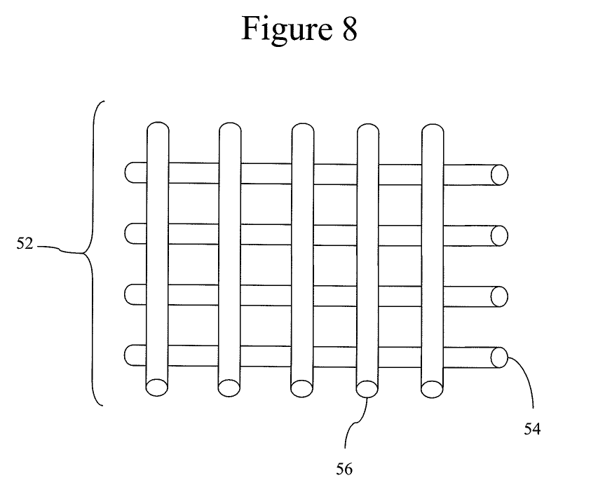

Example FIG. 8 illustrates a mesh of fibers (including conductive nano-particle layers), in accordance with embodiments.

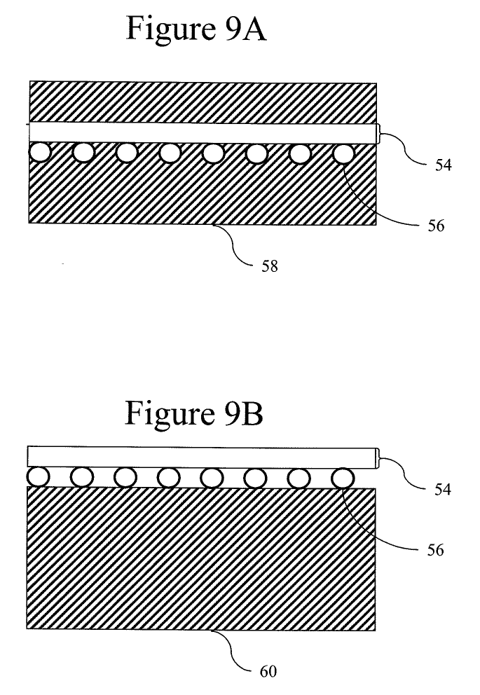

Example FIG. 9A illustrates a mesh of fibers (including conductive nano-particle layers) integrated into shape memory material, in accordance with embodiments.

Example FIG. 9B illustrates a mesh of fibers (including conductive nano-particle layers) formed over shape memory material, in accordance with embodiments.

### DESCRIPTION

Example FIGS. 3A and 3B illustrates shape memory material layer 18 with an electrode having nano-size conductive particles that does not substantially deteriorate due to changes in shape of the shape memory material layer 18, in accordance with embodiments. FIG. 3A illustrates shape memory material layer 18 bonded to first linking agent material layer 16. First linking agent material layer 16 may be also bonded to first nano-particle material layer 14. First nano-particle material layer 14 may be also bonded to second linking agent material layer 12. Second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

First nano-particle material layer 14 includes nanoparticles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may be either electrostatic bonding and/or covalent bonding. Nano-particles 22 may not be substantially bonded to each other. Accordingly, as first linking agent material layer 16 expands or contracts, the bond between the nano-particles 22 and first linking agent material layer 16 is not significantly compromised.

As illustrated in example FIG. 3B, when an apparatus including nano-particles 22 and first linking material layer 16 is stretched or strained, nano-particles 22 remain bonded to first linking material layer 16. Since nano-particles 22 of first nano-particle material layer 14 are not bonded to each other, stretching or straining of first linking material layer 16 does not significantly compromise the robustness of first nano-particle material layer 14.

Although nano-particles 22 in first nano-particle material layer 14 are not bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold). Although straining or stretching of first linking material layer 16 may reduce the resistance of first nano-particle material layer 14 (due to an increase in distance between neighboring nano-particles 22), first nano-particle material layer 14 may remain conductive even when stressed or strained.

Second linking agent material layer 12 may also be bonded to first nano-particle material layer 14, with the same or similar bonding mechanism as the bonding between first nano-particle material layer 14 and first linking agent material layer 16, in accordance with embodiments. In embodiments, first linking agent material layer 16 and second linking agent material layer 12 may include the same material and/or configuration. In embodiments, first linking agent material layer 16 and second linking agent material layer 12 may include different materials and/or configurations.

Second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

As illustrated in example FIGS. 4A and 4B, a nano-particle material layer (e.g. third nano-particle material layer 26 with nano-particles 24) may be formed between first linking agent layer 16 and shape memory material layer 18. In other words, in embodiments, a shape memory material layer (e.g. shape memory material layer 18) may be bonded directly with a nano-particle material layer (e.g. third nano-particle material layer 26) or indirectly through a linking agent layer (e.g. first linking agent layer 18).

In embodiments, a shape memory material layer and linking agent material layer(s) may have the same, similar, and/or compatible elastic properties. In other words, when shape memory material layer is deformed through stress or straining, the elasticity of linking agent material layer(s) may not prevent a shape memory material layer from deforming. Since nano-particle material layer(s) include individual nano-particles that are independently bonding to an adjacent shape memory material layer(s) and/or linking agent material layer(s), nano-particle material layer(s) may not prevent a shape memory material from deforming, in accordance with embodiments. Further, during deformation of a shape memory material layer, nano-particle material layers may not be subjected to significant mechanical strain, since there is substantially no bonding between adjacent nano-particles in the nano-particle material layer(s), in accordance with embodiments.

Nano-particles (e.g. nano-particles 20, nano-particles 22, and/or nano-particles 24) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials.

Through self assembly, nano-particles may be substantially uniformally and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a shape memory material layer). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thinkness that is approximately the diameter of the individual nano-particles. Through a self-assembly deposition method, nano-particles that do not bond to a host layer may be removed, so that a nano-particles material layer is formed that is relatively uniform in thinkness and material distribution.

Linking agent material layer(s) (e.g. first linking agent material layer 16 and/or second linking agent material layer 12) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is stretched, strained, and/or deformed, bonded nano-particles will move with sites of the linking agent material layer to which they are bonded, thus avoiding any disassociation of the nano-particles from their host during deformation.

In embodiments, shape memory material layer(s) (e.g. shape memory material layer 18) may be a material that has the ability to be deformed from its original shape, hold a new deformed shape for a predetermined period of time, and then return to its original shape again. Examples of shape memory materials are shape memory polymers and shape memory metal alloy, both which may be implemented in shape memory material layer 18, in accordance with embodiments. Shape memory polymer may be deformed from an original shape upon application of heat of the glass transition temperature (T_{g}). When heat above the glass transition temperature is applied, a shape memory polymer may be deformed into a new shape. If a shape memory polymer is cooled below the glass transition temperature while being deformed in the new shape, then the shape memory polymer will remain in the new shape.

For example, a shape memory polymer material may have an original shape (e.g. the shape of shape memory material layer 18 in example FIGS. 3A and 4A), with the material being unstrained. Upon application of strain and heat (above the glass transition temperature), the shape of the shape memory material may be deformed into a deformed shape (e.g. the shape of shape memory material layer 18 in example FIGS. 3B and 4B). If the shape memory material is maintained in the deformed shape (e.g. through continuous application of strain) while being cooled below its glass transition temperature, then the deformed shape may be substantially maintained without the application of external strain. If the shape memory material in its deformed shape (e.g. the shape of shape memory material layer 18 in example FIGS. 3B and 4B) is heated again above its glass transition temperature (without the application of external strain), it will return to its original shape (e.g. the shape of shape memory material layer 18 in example FIGS. 3A and 4A).

Accordingly, applications of shape memory materials may extend to applications in aerospace technologies, automotive technologies, electronics, entertainment, and any other application where repeatable shape changing is a desired feature. As an example, in aerospace satellite applications, shape memory materials may be applied in deployable structures (e.g. a deployable antenna). For example, a deployable antenna formed of a flexible material may be compactly stored in a secure compartment during launching and orbiting of a satellite. Once in orbit, the antenna with shape memory materials may be deployed by application of heat (through electrodes). The shape memory material may be specifically tailored to have a glass transition temperature for specific applications. For example, in some satellite applications, the glass transition temperature may be tailored between approximately −127° C. and approximately 3° C., in accordance with embodiments. In embodiments, the glass transition temperature may be tailored to be above approximately 3° C. In embodiments, the glass transition temperature may be tailored to be below approximately −127° C. However, shape memory material may be tailored for virtually any glass transition temperature based on the application, in accordance with embodiments.

In embodiments, shape memory material may include at least one of a polysiloxane material, a polyurethane, and/or a siloxane-urethane copolymer. However, one of ordinary skill in the art would appreciate other similar materials that may be used, depending on the application, in accordance with embodiments. In embodiment, shape memory material may include at least one of fluorine, amine, thiol, phosphine, nitrile, phthalonitrile, hydroxyl, and/or a metal complexing moiety material. For example, at least one of polysiloxane, polyurethane, and or a siloxane-urethane copolymer may be fluorinated with fluorine to tailor the glass transition temperature. For example, a siloxane polymer may have a glass transition temperature of approximately −127° C. without fluorination, approximately −98° C. with a 50% mole percentage of fluorine, and −80° C. with a 100% mole percentage of fluorine, in accordance with embodiments. For example, a urethane polymer may have a glass transition temperature of approximately −75° C. without fluorination, approximately −28° C. with a 50% mole percentage of fluorine, and 3° C. with a 100% mole percentage of fluorine, in accordance with embodiments.

A glass transition temperature may be tailored by implementation of the Fox equation with the integration of two different shape memory materials. In the Fox equation,

$$\frac{1}{{T}_{g}} ≡ \frac{{W}_{1}}{{T}_{g 1}} + \frac{{W}_{2}}{{T}_{g 2}} ,$$

the glass transition temperature (T_{g}) of a shape memory material may be calculated and/or estimated by the relationship of the mole ratio (W₁) of a first shape memory material, the glass transition temperature of the first material (T_{g1}), the mole ratio (W₂) of a second shape memory material, the glass transition temperature of the second material (T_{g2}).

In embodiments, shape memory material (e.g. shape memory material layer 18) may be covalently and/or electrostatically bonded to a linking agent material layer (e.g. first linking agent material layer 16 illustrated in example FIGS. 3A and 3B) and/or a nano-particle material layer (e.g. third nano-particle material layer 26 in example FIGS. 4A and 4B). In embodiments, materials of shape memory material may be polarized to enable electrostatic and/or covalent bonding.

Example FIG. 5 illustrates a conductive nano-particle layer and a linking agent layer formed over a fiber to form flexible conductive fiber 30, in accordance with embodiments. First linking agent material layer 32 may be formed on fiber 28, in accordance with embodiments. First nano-particle material layer 34 may be formed on first linking agent material layer 32 by bonding (e.g. electrostatic bonding and/or covalent bonding) nano-particles to site of first linking agent material layer 32. Additional linking agent material layers (e.g. second linking agent material layer 36) and nano-particle material layers (e.g. second nano-particle material layer 38) may be formed, in accordance with embodiments. Although only two linking agent layers (i.e. first linking agent material layer 32 and second linking agent material layer 36) and two nano-particle material layers (i.e. first nano-particle material layer 34 and second nano-particle material layer 38) are illustrated, embodiments may include any number of linking agent material layers and nano-particle material layers (including just one nano-particle material layer and/or linking agent material layer).

In embodiments, linking agent material layers (i.e. first linking agent material layer 32 and second linking agent material layer 36) may be of a flexible material (e.g. an elastomeric polymer). Accordingly, conductive fiber 30 may be formed that has relatively highly conductive attributes and substantially maintain the physical flexibility and robustness of the host fiber, in accordance with embodiments.

Example FIG. 6 illustrates a deregistered fiber array 40 (including conductive nano-particle layers), in accordance with embodiments. In embodiments, a fiber tow (e.g. a raw high performance fiber tow) may have its fibers 42 deregistered and subsequently processed to include nano-particle material layer(s) and linking agent material layer(s) to form a conductive fiber array 40. In embodiments, fibers 42 may be processed, as illustrated in example FIG. 5.

As illustrated in example FIG. 7A deregistered fiber array 44 (including conductive nano-particle layers) may be formed in an array that is integrated into shape memory material 46, in accordance with embodiments. As illustrated in example FIG. 7B deregistered fiber array 48 (including conductive nano-particle layers) may be formed in an array that is formed on and/or over shape memory material, in accordance with embodiments. Fiber array 44 and/or fiber array 48 may be implemented as electrodes for generating heat in shape memory materials, in accordance with embodiments. Other embodiments include applications of a fiber array that are not in conjunction with shape memory materials.

Example FIG. 8 illustrates a mesh 52 of fibers (including conductive nano-particle layers), in accordance with embodiments. Mesh 52 may include fibers 56 that are spatially orientated in a first direction and fibers 54 that are orientated in a second direction different than the first direction, in accordance with embodiments. Mesh may be formed through a variety of different structural interrelationships between fiber (e.g. to form textiles). Fibers 56 and/or fibers 54 may be processed, as illustrated in example FIG. 5. Accordingly, a mesh (e.g. mesh 52) may be formed that is relatively highly conductive, yet maintains the flexibility of the host fibers, in accordance with embodiments.

Mesh 52 of fibers may have many different applications, in accordance with embodiments. Example FIG. 9A illustrates a mesh of fibers (including conductive fibers 54 and 56) integrated into shape memory material 58, in accordance with embodiments. Fibers 54 and 56 may serve as an electrode for shape memory material. Example FIG. 9B illustrates a mesh of fibers (including conductive fibers 54 and 56) formed over shape memory material, in accordance with embodiments.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-20. (canceled)

21. A method comprising:
forming at least one nano-particle layer;
forming at least one linking agent layer, wherein said at least one nano-particle layer is bonded to said at least one linking agent layer; and
forming a shape memory material layer, wherein at least one of said at least one nano-particle layer and said at least one linking agent layer are bonded to the shape memory material layer.

22. The method of claim 21, wherein said at least one nano-particle layer comprises conductive nano-size particles.

23. The method of claim 22, wherein:
said at least one nano-particle layer is comprised in an electrode; and
the electrode is configured to generate heat in the shape memory material through electricity to raise the shape memory material layer above the glass transition temperature of the shape memory material layer.

24. The method of claim 23, wherein the electrode is substantially resilient to deformation of said at least one linking agent layer and said shape memory layer due to individual bonding of individual particles of said at least one nano-particle layer to at least one of said at least one linking agent layer and said shape memory material layer.

25. The method of claim 22, wherein said conductive nano-size particles comprises gold nano-size particles.

26. The method of claim 25, wherein said gold nano-size particles comprises gold clusters each having a diameter less than approximately 1000 nanometers.

27. The method of claim 26, wherein said gold nano-size particles comprises gold clusters having a diameter less than approximately 50 nanometers.

28. The method of claim 21, wherein:
said at least one nano-particle layer is bonded to said at least one linking agent layer by at least one of electrostatic bonding and covalent bonding; and
at least one of said at least one nano-particle layer and said at least one linking agent layer are bonded to the shape memory material layer by at least one of electrostatic bonding and covalent bonding.

29. The method of claim 21, wherein:
said at least one linking agent layer is an elastomeric polymer;
individual particles of said at least one nano-particle layer are bonded to sites of the elastomeric polymer; and
at least one of individual particles of said at least one nano-particle layer and sites of the elastomeric polymer are bonded to sites of the shape memory material layer.

30. The method of claim 21, wherein at least one of said at least one nano-particle layer, said at least one linking agent layer, and said shape memory material layer is polarized.

31. The method of claim 21, wherein the shape memory material layer has a glass transition temperature in the range of approximately −127° C. to approximately 3° C.

32. The method of claim 21, wherein the shape memory material layer has a glass transition temperature above approximately 3° C.

33. The method of claim 21, wherein the shape memory material layer has a glass transition temperature below approximately −127° C.

34. The method of claim 21, wherein the shape memory material layer comprises polysiloxane.

35. The method of claim 21, wherein the shape memory material layer comprises polyurethane.

36. The method of claim 21, wherein the shape memory material layer comprises a siloxane-urethane copolymer.

37. The method of claim 21, wherein the shape memory material layer comprises at least one of fluorine, amine, thiol, phosphine, nitrile, phthalonitrile, hydroxyl, and a metal complexing moiety material.

38. A method comprising forming a conductive fiber by:
forming at least one nano-particle layer over a surface of a fiber; and
forming at least one linking agent layer by bonding said at least one linking agent layer to said at least one nano-particle layer.

39. The method of claim 38, wherein the conductive fiber is configured to raise the glass transition temperature of a shape memory material coupled to the conductive fiber.

40. The method of claim 38, comprising forming at least one of:
a fiber array; and
a mesh.
